(19) United States
(12) Patent Application Publication
(10) Pub. No.: US 2025/0330387 A1
(43) Pub. Date: Oct. 23, 2025

(54) METHOD AND SYSTEM FOR PERFORMING PREDICTIVE MAINTENANCE IN DECENTRALIZED COMMUNICATION NETWORKS

(71) Applicant: Elisa Oyj, Helsinki (FI)

(72) Inventor: Alexander NIKITIN, Helsinki (FI)

(73) Assignee: Elisa Oyj, Helsinki (FI)

(21) Appl. No.: 18/872,128

(22) PCT Filed: Jun. 6, 2023
(86) PCT No.: PCT/FI2023/050323

§ 371 Date: Dec. 5, 2024

(30) Foreign Application Priority Data
Jun. 22, 2022 (FI) 20225567

(51) Int. Cl. H04L 41/149; H04L 41/16

(52) U.S. Cl. CPC H04L 41/149; H04L 41/16

(57) ABSTRACT

A method for performing predictive maintenance in a communication network, such as a decentralized communication network includes forming a training dataset using communication and anomaly data of communication nodes in communication network; building predictive maintenance client models and a predictive maintenance server model through machine learning using training dataset; deploying predictive maintenance client models and predictive maintenance server model in plurality of client nodes and server node, respectively; sensing an anomaly by a client node of plurality of client nodes; sending an aggregated information, by client node to server node; and performing a maintenance action by server node based on a decision made by server node on aggregated information. Disclosed also is a system for performing predictive maintenance in a communication network.

### TECHNICAL FIELD

The present disclosure relates to method for performing predictive maintenance in a communication network. The present disclosure also relates to system for performing predictive maintenance in a communication network.

### BACKGROUND

In recent past, Artificial Intelligence (AI) machine learning (ML) tools are conquering every sector by providing new dimensions across all industries and accelerating digital transformation. Within telecoms, the rise of 5G has opened the flood gates to a whole new world of opportunities and possibilities now possible with AI and ML. AI and ML in mobile network infrastructure is expected to lower costs by automating functions that typically require human interaction and to speed new revenue-generating service offerings, which becomes increasingly important in the deployment of edge, open radio access networks (Open RAN), and cloud-native 5G cores.

Another common use of AI and ML in telecommunications is building self-optimizing networks (SONs) and self-healing radio networks (SHRNs), respectively. Typically, the SONs are automatically monitored by AI algorithms that detect and accurately predict network anomalies and the SHRNs automatically detect issues and take corrective actions. In the area of system monitoring, anomaly detection systems are crucial for identifying performance issues and problematic network behaviour. Proactively predicting the degradation of key performance indicators, and identifying the likely root cause, can help reduce and prevent outages. Furthermore, such technologies (and other technologies such as deep learning and reinforcement learning) can proactively optimize and reconfigure the network to ensure that end-users enjoy the stable performance. However, such technologies fail to secure personal or sensitive data of the multiple participant nodes in the network.

Therefore, in light of the foregoing discussion, there exists a need to overcome the aforementioned drawbacks associated with conventional methods for predictive maintenance over networks.

### SUMMARY

The present disclosure seeks to provide a method for performing predictive maintenance in a communication network. The present disclosure also seeks to provide a system for performing predictive maintenance in a communication network. An aim of the present disclosure is to provide a solution that overcomes at least partially the problems encountered in prior art.

In one aspect, an embodiment of the present disclosure provides a method for performing predictive maintenance in a communication network, the method comprising:
forming a training dataset using communication data and anomaly data of communication nodes in the communication network, wherein the communication nodes comprise a plurality of client nodes and a server node communicably coupled to each other;
building predictive maintenance client models and a predictive maintenance server model through machine learning using the training dataset, wherein the predictive maintenance client models are based on types of the plurality of client nodes;
deploying the predictive maintenance client models and the predictive maintenance server model in the plurality of client nodes and the server node, respectively;
sensing an anomaly by a client node of the plurality of client nodes;
sending an aggregated information, by the client node to the server node, comprising an anomaly information and a predictive maintenance action predicted by a predictive client maintenance model corresponding to the client node based on the anomaly information; and
performing a maintenance action by the server node based on a decision made by the server node on the aggregated information.

In another aspect, an embodiment of the present disclosure provides a system for performing predictive maintenance in a communication network, the system comprising:
a plurality of client nodes; and
a server node, wherein the plurality of the client nodes and the server nodes are communicably coupled to each other,
wherein each client node of the plurality of client nodes is having a processor operable to
   build a predictive maintenance client model for each client node using anomaly data associated therewith, wherein the predictive maintenance client model is based on a type of a client node;
   deploy the predictive maintenance client models in the plurality of client nodes;
   sense an anomaly; and
   send an aggregated information, to the server node, comprising an anomaly information and a predictive maintenance action predicted by a predictive client maintenance model corresponding to the client node based on the anomaly information,
and wherein the server node having a processor operable to
   build a predictive maintenance server model using communication data and anomaly data of the communication network;
   deploy the predictive maintenance server model in the server node; and
   perform a maintenance action based on a decision made by the server node on the aggregated information.

In yet another aspect, an embodiment of the present disclosure provides a computer program product comprising a non-transitory machine-readable data storage medium having stored thereon computer-executable program code that, when executed by a processor, cause the system to carry out the aforementioned method.

Embodiments of the present disclosure substantially eliminate or at least partially address the aforementioned problems in the prior art and provides an improved method and an efficient system for performing federated predictive maintenance over networks of objects which may be decentralized (i.e. each client node configured to not share any personal or sensitive data to a central server node). Beneficially, the method allows for better computational efficiency and privacy in predictive maintenance applications. The method may also be applied to different applications in telecommunications, for example, cable networks monitoring, wireless networks monitoring, and monitoring of the networks of the computers. Additionally, the disclosed method is cost-efficient as compared to conventional methods.

Additional aspects, advantages, features and objects of the present disclosure would be made apparent from the drawings and the detailed description of the illustrative embodiments construed in conjunction with the appended claims that follow.

It will be appreciated that features of the present disclosure are susceptible to being combined in various combinations without departing from the scope of the present disclosure as defined by the appended claims.

### BRIEF DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those skilled in the art will understand that the drawings are not to scale. Wherever possible, like elements have been indicated by identical numbers.

Embodiments of the present disclosure will now be described, by way of example only, with reference to the following diagrams wherein:

FIG. 1 is a flowchart depicting steps of a method for performing predictive maintenance in a communication network, in accordance with an embodiment of the present disclosure;

FIG. 2 is a schematic illustration of network of client nodes and a server node, in accordance with an embodiment of the present disclosure;

FIG. 3 is a schematic illustration of the communication process, in accordance with an embodiment of the present disclosure; and

FIG. 4 is a schematic illustration of timestamps of several communication rounds, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DETAILED DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practising the present disclosure are also possible.

In one aspect, an embodiment of the present disclosure provides a method for performing predictive maintenance in a communication network, the method comprising:
forming a training dataset using communication data and anomaly data of communication nodes in the communication network, wherein the communication nodes comprise a plurality of client nodes and a server node communicably coupled to each other;
building predictive maintenance client models and a predictive maintenance server model through machine learning using the training dataset, wherein the predictive maintenance client models are based on types of the plurality of client nodes;
deploying the predictive maintenance client models and the predictive maintenance server model in the plurality of client nodes and the server node, respectively;
sensing an anomaly by a client node of the plurality of client nodes;
sending an aggregated information, by the client node to the server node, comprising an anomaly information and a predictive maintenance action predicted by a predictive client maintenance model corresponding to the client node based on the anomaly information; and
performing a maintenance action by the server node based on a decision made by the server node on the aggregated information.

In another aspect, an embodiment of the present disclosure provides a system for performing predictive maintenance in a communication network, the system comprising:
a plurality of client nodes; and
a server node, wherein the plurality of the client nodes and the server nodes are communicably coupled to each other,
wherein each client node of the plurality of client nodes is having a processor operable to
   build a predictive maintenance client model for each client node using anomaly data associated therewith, wherein the predictive maintenance client model is based on a type of a client node;
   deploy the predictive maintenance client models in the plurality of client nodes;
   sense an anomaly; and
   send an aggregated information, to the server node, comprising an anomaly information and a predictive maintenance action predicted by a predictive client maintenance model corresponding to the client node based on the anomaly information,
and wherein the server node having a processor operable to
   build a predictive maintenance server model using communication data and anomaly data of the communication network;
   deploy the predictive maintenance server model in the server node; and
   perform a maintenance action based on a decision made by the server node on the aggregated information.

In yet another aspect, an embodiment of the present disclosure provides a computer program product comprising a non-transitory machine-readable data storage medium having stored thereon computer-executable program code that, when executed by a processor, cause the system to carry out the aforementioned method.

The present disclosure provides the aforementioned method that provides a secure predictive maintenance over the network of objects that are decentralized, i.e., each client does not send any personal or sensitive data to the central server node, such as in a decentralized communication network or a federated communication network.

Advantageously, issues related to specific client nodes may be tracked and detailed solutions and troubleshooting may be provided using the aforementioned method and the aforementioned system by the processors associated with each of the client nodes and the server node. Furthermore, the aforementioned method and the aforementioned system may proactively optimize and reconfigure the network to ensure that end-users enjoy the stable performance. Moreover, the disclosed method provides a cost-efficient, accurate, and fast performance of the system as compared to the conventional systems.

The method comprises forming a training dataset using communication data and anomaly data of communication nodes in the communication network, wherein the communication nodes comprise a plurality of client nodes and a server node communicably coupled to each other. The term “communication network” as used herein refers to a network model created from various interacting nodes, namely the plurality of client nodes and the server node. The communication network allows said client nodes to interact with each other and strengthen their relationships by enabling efficient and secure transactions or communication amongst themselves. The communication network comprises a plurality of client nodes connected together or to the server nodes via connections therebetween. The connections depict flow of information from one client node (namely sender) to another client node (namely receiver) or to the server node through the communication network.

In an embodiment, the plurality of client nodes may represent heterogenous systems (such as mobile phones, IoT devices, and so on) functioning cooperatively to accomplish a desired task. In an example, the plurality of client nodes may represent financial institutions (such as banks, central banks, regulators, auditors, investors, payment and securities settlement systems, and other third parties) functioning cooperatively to accomplish a desired task, such as transactions therebetween.

Optionally, the communication network is selected from any of: a decentralized communication network, a federated communication model. Notably, the decentralized communication network employs machine learning technique to train an algorithm across decentralized system comprising decentralized client nodes and/or servers, such that different client nodes and/or the central node are independently trained, and wherein each client node is configured to not share any personal or sensitive data to a central server node. Typically, the decentralized communication network rely on powerful communication network and systems with varied computational capabilities. Herein, only machine learning parameters (i.e. results and not the data itself) from each node are exchanged between the nodes with such parameters encrypted before sharing between learning rounds to extend privacy and homomorphic encryption schemes can be used to directly make computations on the encrypted data without decrypting them beforehand. This allows sensitive data to remain in local sites, i.e. at specific client nodes, thereby reducing possibility of sensitive data breaches.

It will be appreciated that not just in the decentralized setting, but the method is configured for performing in federated (or collaborative) learning setting. The method is configured for performing federated predictive maintenance over networks of objects which may be decentralized, centralized or hetero-centralized. Typically, the federated learning is a machine learning technique that trains an algorithm across multiple decentralized system comprising decentralized client nodes and/or servers holding local data without exchanging them amongst each other, i.e. maintaining data security, data privacy, data access rights, and so on in a secure way. In this regard, the federated predictive maintenance employs training heterogenous datasets from a plurality of client nodes (such as mobile phones, IoT devices, and so on) in multiple iterations at the location of each client node without requiring data to be pooled into a single location (as in the conventional machine learning technique). and rely on less powerful communication network and systems with varied computational capabilities to minimize the number of communications between the nodes.

The term “training dataset” as used herein refers to the initial data used to train machine learning models and/or artificial intelligence models. These training datasets are fed to machine learning algorithms and/or artificial intelligence models to teach them how to make predictions or perform a desired task. The term “communication data” as used herein refers to a data communicated from each of the plurality of client nodes in the network. The term “anomaly data” as used herein refers to a data that relates to sudden and short-lived deviation from the normal operation of the network. Notably, the anomaly data is suitable for analysis to draw out inferences related to the anomalies that occur in the client nodes. Some anomalies are deliberately caused by intruders with malicious intent such as a denial-of-service attack in an IP network. The term “node” as used herein refers to a client or an element or, more atomically, pieces of equipment in a network such as amplifiers, cable modems, etc., whereas, each node may be of a unique type.

Moreover, the method comprises building predictive maintenance client models and a predictive maintenance server model through machine learning using the training dataset, wherein the predictive maintenance client models are based on types of the plurality of client nodes. The term “predictive maintenance client models” as used herein refers to the machine learning models that are trained in the individual client nodes using the respective training datasets of the client nodes generated using the anomaly data in the network. The term “predictive maintenance server model” as used herein refers to the machine learning model that is trained in the central server node using the aggregated information collected from the plurality of the client nodes in the network. It will be appreciated that each client node may have a specific type of predictive maintenance client models.

Optionally, the predictive maintenance client models are trained using anomaly data. Herein, the anomaly data associated with each client node enables training a specific predictive maintenance client model associated with a given client node.

Optionally, the predictive maintenance client models, are operable to recognise patterns related to anomalies of the client nodes, using the anomaly data. Typically, the initial training dataset is formed by using the tickets and reports collected about the client nodes, whereas a separate dataset is collected for each client node type. Furthermore, the datasets are used to train a model, and then for each client node the corresponding trained model is deployed to the respective client node.

Optionally, the predictive maintenance server model is trained using the communication data and the anomaly data. Herein, the communication data and the anomaly data provides a wider scope of interaction between the plurality of client nodes and each of the client nodes with the server as well as anomalies associated with each client node. In this regard, the communication data and the anomaly data serve as a local dataset that takes into account global weights of the plurality of client nodes and the server node communicating with each other.

Moreover, the method comprises deploying the predictive maintenance client models and the predictive maintenance server model in the plurality of client nodes and the server node, respectively. Herein, the predictive maintenance client models specific to the client nodes are deployed and similarly, the predictive maintenance server model is deployed in the server node.

Optionally, deploying, information related to the re-training of the predictive maintenance server model, by the server node into the corresponding client nodes. The selected server aims to analyse the interaction in the network by deploying the predictive maintenance server model in the plurality of client nodes and perform the maintenance actions. The predictive maintenance server model performs the predictive maintenance by finding the patterns in the historical data. In this regard, an initial training dataset is formed from data collected about the nodes, wherein each node type (such as the client nodes or the server nodes) comprises a separate dataset that is used to train the predictive maintenance server model. Subsequently, the trained predictive maintenance server model is deployed to the node based on whose dataset the predictive maintenance server model is trained. The predictive maintenance server model then operates and regularly asynchronically re-trains the node on the most recent data and sends the prediction to the central server node along with additional data to respond back with information useful for fine-tuning the predictive maintenance server model. The predictive maintenance server model in the plurality of client nodes may accurately anticipate and warn about possible hardware failures that allows telephone company to be very proactive at maintaining their equipment, fixing issues before they occur, and affect the end-user.

Optionally, the method comprises asynchronous retraining of the predictive maintenance server model so that the time consumed in training one node (client or server) is independent of another node.

Moreover, the method comprises sensing the anomaly by a client node of the plurality of client nodes and sending the aggregated information, by the client node to the server node, comprising an anomaly information and a predictive maintenance action predicted by a predictive client maintenance model corresponding to the client node based on the anomaly information. Herein, the term “predictive maintenance action” refers to a tentative maintenance action to performed on a given client node based on an anomaly information associated therewith. It will be appreciated that each of the plurality of client nodes having a processor associated therewith are trained by a specific predictive client maintenance model. Herein, the term “aggregated data” refers to a form data that is processed and summarized to provide a general view of the anomaly information and the predictive maintenance action.

The aggregated information is collected from the total ‘n’ nodes over the network, where each node may have one type such as amplifiers, cable modems, etc in cable networks. Optionally, the aggregated information precludes sensitive data associated with the plurality of client nodes. The term “sensitive data” as used herein refers to the personal or private data of the plurality of the client nodes over the network. Furthermore, the method performs the predictive maintenance in a secure way, that allows utilizing private data collected from a client node without giving access to it to a third party. In this regard, the method comprises collecting only the aggregated information from the plurality of client nodes and not all the measurements therefrom. Moreover, the method comprises collocating a computational engine with each client node. In some cases, the collocated computational engine can be a part of the client node (e.g., workstation network); in other cases, it can be manually collocated with the client node (e.g., a small computing engine such as Arduino) which aggregated information for a specific client node. The central server node does not receive any personal or sensitive data from the client nodes and serves purely as a decision-making engine.

Moreover, the method comprises performing a maintenance action by the server node based on a decision made by the server node on the aggregated information.

Optionally, the maintenance action comprises initiating an automated maintenance procedure for the client node, when the aggregated information is recognizable by the predictive maintenance server model. The automated maintenance procedure is initiated when the predictive model recognises that a particular client node from the plurality of client nodes starts malfunctioning such as the automated maintenance procedure may predict the time until the next break.

Optionally, the central server node comprises re-training the predictive maintenance server model based on the aggregated information, when the aggregated information is un-recognizable by the predictive maintenance server model. The aggregated information is sent to the central server node along with the additional data for the re-training of the predictive maintenance server model. Furthermore, the central server node responds back with information useful for fine-tuning the predictive maintenance server model. Alternatively, another approach is to extract the aggregated information from the nodes and send the aggregated information to the server node, that will use a predictive maintenance server model and then propagate the insights forward to another system or a domain expert. Optionally, the method is configured to perform an asynchronous re-training of the predictive maintenance server model.

Optionally, the predictive maintenance server model is operable to:
recognise patterns related to the anomalies of the client nodes communicably coupled to the server node;
recognise patterns related to communication patterns between the server node and the client nodes; and
recognise patterns related to the anomalies of the client nodes not communicably coupled to the server node.

Throughout the present disclosure, the term “patterns related to anomalies” refers to certain recognisable features and characteristics related to a type of anomalies that can occur in the client nodes. Notably, recognition of the patterns related to the anomalies of the client nodes enables to analysis to identify factors such as regular causes of anomalies, regular timing of anomalies, and the like. Subsequently, the predictive maintenance server model is able to make use of such identified factors to beneficially, make more efficient and quicker predictive decisions to perform the maintenance action. It will be appreciated that the predictive maintenance server model even recognises the patterns related to the anomalies of the client nodes that are not communicably coupled to server node, thus, making predictive decisions in advance for a time instance when those client nodes are communicably coupled to the server node. Throughout the present disclosure, the term “communication patterns of between the server node and the client nodes” refers to specific features and characteristics that related to the communication that is taking place between the server node and the client nodes. For example, type of communication interface between the server node and the client nodes, signal strength of communication between the server node and the client nodes, and the like, are some examples of the recognised patterns related to communication patterns between the server node and the client nodes which helps the predictive maintenance server model to determine what maintenance action is suitable for which of the client node. The technical effect is that the recognition of the patterns related to anomalies of the client nodes communicably coupled with the server node, recognition of the patterns related to anomalies of the client nodes not communicably coupled with the server node, and recognition of the patterns related to the communication patterns between the server node and the client nodes, enables the predictive maintenance server model to make quick, suitable and efficient decision to perform the maintenance action.

In this regard, during each communication round between the plurality of client nodes and the server node, the consistency between the client nodes and the server node is checked. Moreover, the client nodes try to pull the newest updated version if the versions on a client node and the server node are inconsistent. The server node has the access to the mutual data between the client nodes. It will be appreciated that the server node, over the network, is stored in a S3-compatible storage, whereas, the client nodes do not have access to the mutual data between the client nodes and the server node over the network. The all mutual meta-information that are stored in a cloud key-value storage between each of plurality of client nodes and the server node is accessible by the client nodes (read-only) and the server node.

It will be appreciated that the aforementioned method may be applied not only to communication networks comprising a plurality of client nodes interacting with each other, however, even in such cases, the client nodes should be able to send data to the server node.

The present disclosure also relates to the system as described above. Various embodiments and variants disclosed above apply mutatis mutandis to the system.

The term “processor” as used herein refers to an application, program, process or device that responds to requests for information or services by another application, program, process or device (such as the external device) via a network interface. Optionally, the processor also encompasses software and the memory including the computer-executable program code that makes the act of serving information or providing services possible. It may be evident that the communication means of an external device may be compatible with a communication means of the processor, in order to facilitate communication therebetween.

Optionally, each client node of the plurality of client nodes is associated with an Arduino. Alternatively, optionally, each client node of the plurality of client nodes may be associated with any other computing device.

Optionally, the processor of the predictive maintenance server model is operable to:
recognise patterns related to the anomalies of the client nodes communicably coupled to the server node;
recognise patterns related to communication patterns between the server node and the client nodes; and
recognise patterns related to the anomalies of the client nodes not communicably coupled to the server node.

Optionally, the system further comprises a communication model. The communication model is configured to analyze the number of communication rounds between the plurality of client nodes and each client node and the server node, and their content to detect the problems in the communication process. Optionally, the communication model may be built via any sequence to sequence model. More optionally, the communication model may be built using variations of RNNs (e.g., LSTMs or GRUs). However, other models, such as Gaussian processes, may be used for building the communication model.

Optionally, the system is configured to employ a semi-supervised network model. The semi-supervised network model is configured to predict potential problems in those client nodes that cannot communicate with the central server node. Moreover, the semi-supervised network model is stored in the central server node. Furthermore, the semi-supervised network model uses for example data on communication rounds to predict future problems for those client nodes that become unresponsive.

Optionally, the communication network is selected from any of: a decentralized communication network, a federated communication model.

The present disclosure also relates to the computer program product as described above. Various embodiments and variants disclosed above apply mutatis mutandis to the computer program product.

Optionally, the computer program product is implemented as an algorithm, embedded in a software stored in the non-transitory machine-readable data storage medium. The non-transitory machine-readable data storage medium may include, but is not limited to, an electronic storage device, a magnetic storage device, an optical storage device, an electromagnetic storage device, a semiconductor storage device, or any suitable combination of the foregoing. Examples of implementation of the computer-readable medium include, but are not limited to, Electrically Erasable Programmable Read-Only Memory (EEPROM), Random Access Memory (RAM), Read Only Memory (ROM), Hard Disk Drive (HDD), Flash memory, a Secure Digital (SD) card, Solid-State Drive (SSD), a computer readable storage medium, and/or CPU cache memory.

### DETAILED DESCRIPTION OF THE DRAWINGS

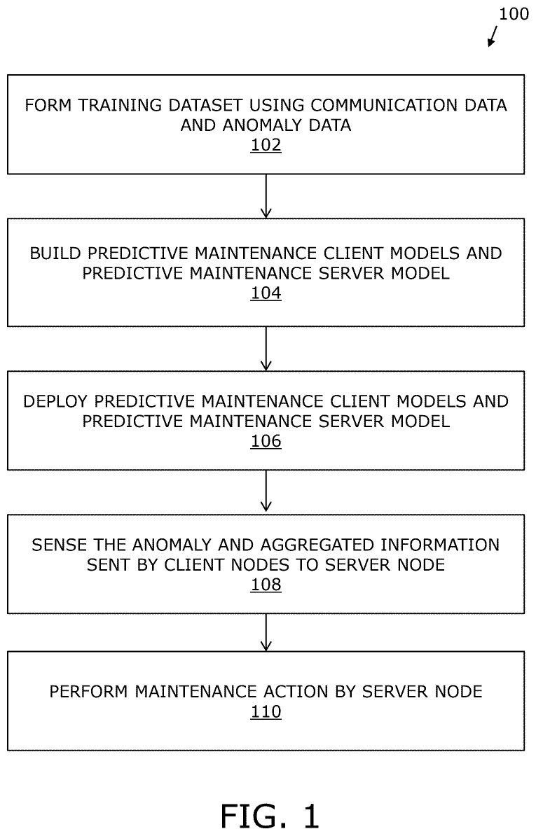

Referring to FIG. 1, there is shown a flowchart 100 illustrating steps of a method for performing predictive maintenance in a communication network, in accordance with an embodiment of the present disclosure. At step 102, a training dataset is formed using communication data and anomaly data of communication nodes in the communication network. At step 104, the predictive maintenance client models and a predictive maintenance server model are built through machine learning using the training dataset. At step 106, the predictive maintenance client models and the predictive maintenance server model are deployed in the plurality of client nodes and the server node, respectively. At step 108, an anomaly is sensed by a client node of the plurality of client nodes, and an aggregated information is sent, by the client node to the server node, comprising an anomaly information and a predictive maintenance action predicted by a predictive client maintenance model corresponding to the client node based on the anomaly information. At step 110, a maintenance action is performed by the server node based on a decision made by the server node on the aggregated information.

The steps 102, 104, 106, 108, and 110 are only illustrative and other alternatives can also be provided where one or more steps are added, one or more steps are removed, or one or more steps are provided in a different sequence without departing from the scope of the claims herein.

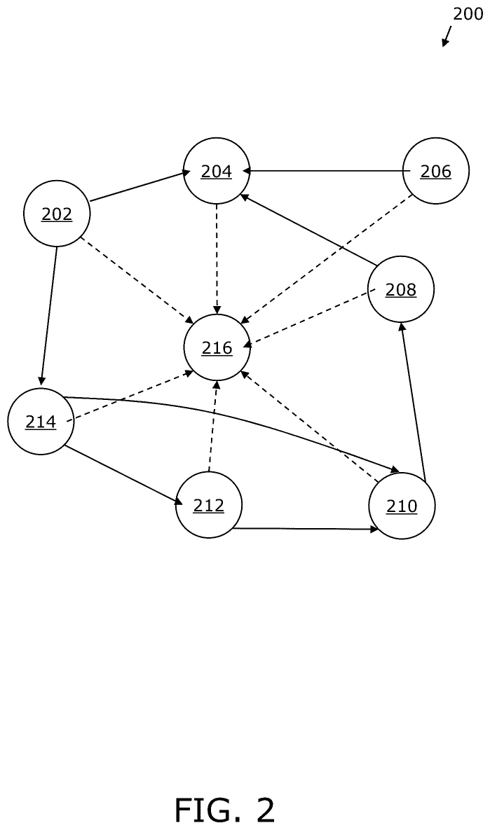

Referring to FIG. 2, shown is a schematic illustration of a communication network 200 of plurality of client nodes, such as client nodes 202, 204, 206, 208, 210, 212 and 214 and a server node, such as the server node 216, in accordance with an embodiment of the present disclosure. Herein the communication network 200 is implemented as a decentralized communication network. As shown each client node, for example, the client nodes 202, 204, 206, 208, 210, 212 and 214, may represent a client or an element in the communication network 200 such as modems and amplifiers and are connected to each other (shown by black arrows between the nodes) and are connected to a central server node, for example, the server node 216 (shown by dashed lines). The selected server node 216 aims to analyse the interaction in the communication network 200 and perform maintenance actions.

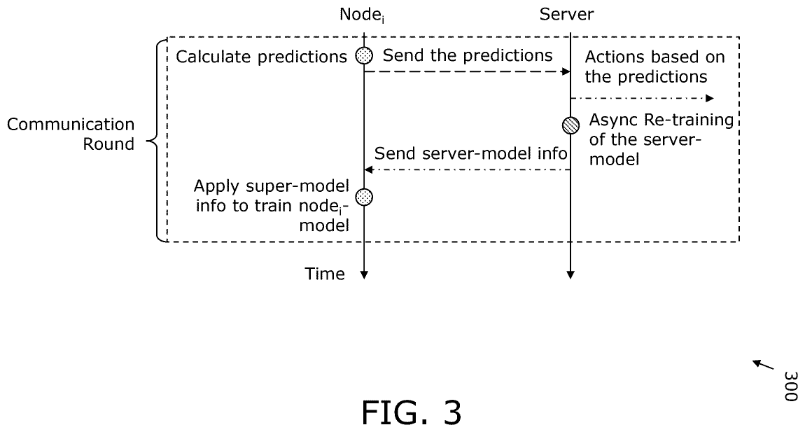

Referring to FIG. 3, shown is a schematic illustration of the communication process 300, in accordance with an embodiment of the present disclosure.

As shown, the communication process 300 is between an arbitrary client node (nodeᵢ) and the server node over time. Initially, the selected client node calculates the predictions using an onsite model Mᵢ, and sends the predictions and additional information to the server node in the communication process 300. The server node makes a decision based on the predictions and may either initiate some maintenance or fixing procedures or do nothing. At last, the server node starts training and sends back information about the predictive maintenance server model.

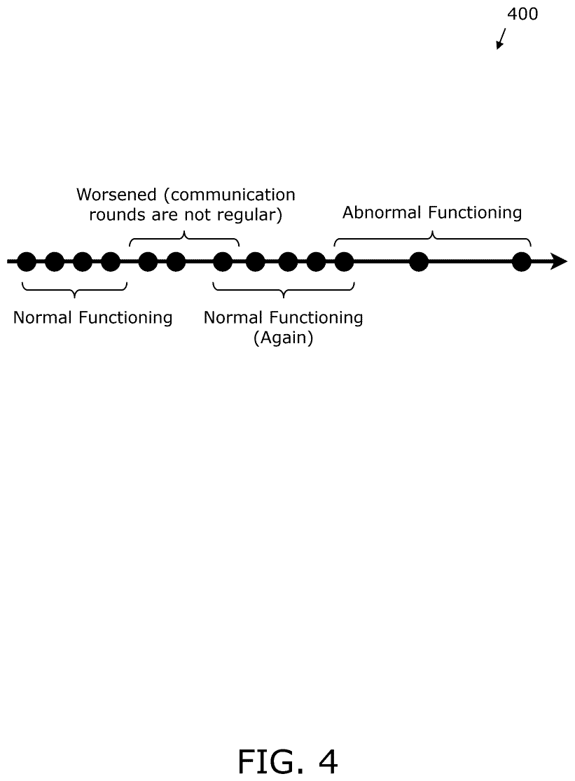

Referring to FIG. 4, shown is a schematic illustration of timestamps 400 of several communication rounds, in accordance with an embodiment of the present disclosure. As shown, the black arrow shows the timestamps 400 of the several communication rounds. The timestamps 400 starts with the normal functioning of communication. The delay between the communication rounds shown by the dark circles. The distance between the dark circles shows the functioning of the model such as the normal or abnormal functioning over the timestamps 400.

Modifications to embodiments of the present disclosure described in the foregoing are possible without departing from the scope of the present disclosure as defined by the accompanying claims. Expressions such as “including”, “comprising”, “incorporating”, “have”, “is” used to describe and claim the present disclosure are intended to be construed in a non-exclusive manner, namely allowing for items, components or elements not explicitly described also to be present. Reference to the singular is also to be construed to relate to the plural.

1. A method for performing predictive maintenance in a communication network, the method comprising:
forming a training dataset using communication data and anomaly data of communication nodes in the communication network, wherein the communication nodes comprise a plurality of client nodes and a server node communicably coupled to each other;
building predictive maintenance client models and a predictive maintenance server model through machine learning using the training dataset, wherein the predictive maintenance client models are based on types of the plurality of client nodes;
deploying the predictive maintenance client models and the predictive maintenance server model in the plurality of client nodes and the server node, respectively;
sensing an anomaly by a client node of the plurality of client nodes;
sending an aggregated information, by the client node to the server node, comprising an anomaly information and a predictive maintenance action predicted by a predictive client maintenance model corresponding to the client node based on the anomaly information; and
performing a maintenance action by the server node based on a decision made by the server node on the aggregated information.

2. The method according to claim 1, wherein the maintenance action comprises initiating an automated maintenance procedure for the client node, when the aggregated information is recognizable by the predictive maintenance server model.

3. The method according to claim 1, wherein the central server node comprises re-training the predictive maintenance server model based on the aggregated information, when the aggregated information is un-recognizable by the predictive maintenance server model.

4. The method according to claim 3, further comprising deploying, information related to the re-training of the predictive maintenance server model, by the server node into the corresponding client nodes.

5. The method according to claim 1, wherein the predictive maintenance client models are trained using anomaly data.

6. The method according to claim 1, wherein the predictive maintenance client models, are operable to recognise patterns related to anomalies of the client nodes, using the anomaly data.

7. The method according to claim 1, wherein the predictive maintenance server model is trained using the communication data and the anomaly data.

8. The method according to claim 1, wherein the aggregated information precludes sensitive data associated with the plurality of client nodes.

9. The method according to claim 1, wherein the predictive maintenance server model is operable to:
recognise patterns related to the anomalies of the client nodes communicably coupled to the server node;
recognise patterns related to communication patterns between the server node and the client nodes; and
recognise patterns related to the anomalies of the client nodes not communicably coupled to the server node.

10. The method according to claim 1, wherein the communication network is selected from any of: a decentralized communication network, a federated communication model.

11. A system for performing predictive maintenance in a communication network, the system comprising:
a plurality of client nodes; and
a server node, wherein the plurality of the client nodes and the server nodes are communicably coupled to each other,
wherein each client node of the plurality of client nodes is having a processor operable to
build a predictive maintenance client model for each client node using anomaly data associated therewith, wherein the predictive maintenance client model is based on a type of a client node;
deploy the predictive maintenance client models in the plurality of client nodes;
sense an anomaly; and
send an aggregated information, to the server node, comprising an anomaly information and a predictive maintenance action predicted by a predictive client maintenance model corresponding to the client node based on the anomaly information,
and wherein the server node having a processor operable to build a predictive maintenance server model using communication data and anomaly data of the communication network;
deploy the predictive maintenance server model in the server node; and
perform a maintenance action based on a decision made by the server node on the aggregated information.

12. The system according to claim 11, wherein the processor of the predictive maintenance server model is operable to:
recognise patterns related to the anomalies of the client nodes communicably coupled to the server node;
recognise patterns related to communication patterns between the server node and the client nodes; and
recognise patterns related to the anomalies of the client nodes not communicably coupled to the server node.

13. The system according to claim 11, wherein the communication network is selected from any of: a decentralized communication network, a federated communication model.

14. A computer program product comprising a non-transitory machine-readable data storage medium having stored thereon computer-executable program code that, when executed by a processor, cause the system to carry out the method of claim 1.
